(19) United States
(12) Patent Application Publication
(10) Pub. No.: US 2026/0039111 A1
(43) Pub. Date: Feb. 5, 2026

(54) Optimization Technique for Electrical Island Frequency Control

(71) Applicant: EMERSON PROCESS MANAGEMENT POWER & WATER SOLUTIONS, INC., Cranberry Twp, PA (US)

(72) Inventors: Xu Cheng, Pittsburgh, PA (US); Frederick C. Huff, Pittsburgh, PA (US)

(21) Appl. No.: 18/791,983

(22) Filed: Aug. 1, 2024

(51) Int. Cl. H02J 3/24; H02J 3/00; H02J 3/32; H02J 3/38

(52) U.S. Cl. CPC H02J 3/241; H02J 3/003; H02J 3/32; H02J 3/381; H02J 3/388; H02J 2203/10; H02J 2203/20; H02J 2300/10

(57) ABSTRACT

A method of controlling an islanded power grid using multiple power generating units operates one of the power generating units in an isochronous mode to perform frequency control on the power grid and operates the other power generating units in droop mode to provide the overall instantaneous power needed on the grid. The method provides better overall efficiency of the power generating system while still enabling robust frequency control by determining the power generating unit to operate in the isochronous mode based on a predicted load demand or load demand change over a near-term time horizon. The method implements an optimization routine that determines the distribution of the power generating load across the power generating units in an efficient or optimal manner, and then selects the isochronous power generating unit as the power generating unit that has the highest capacity with the needed upward and downward reserve for making frequency control movements during the near-term time horizon.

### TECHNICAL FIELD

This patent relates generally to frequency control within an electrical islanded power system, and more particularly to optimizing power generation within an electrical islanded power system while providing robust frequency control.

### BACKGROUND

Islanded electrical grids, which are smaller electrical grids that are isolated within a particular region, such as on an island or in a remote geographical location far from other infrastructure, are scattered around the world. Because an islanded electrical grid is, by definition, isolated from and not connected to a main power grid network of, for example, a country or a wider region, the load demand at any particular time is not typically known exactly and the load demand tends to be more variable. However, it is still important to tightly control the frequency of the power signals placed onto the islanded electrical grid to protect the load equipment connected to the grid.

Generally, a power plant or power generating network, such as that associated with an islanded electrical grid, includes multiple power generating units of different sizes or capacities and may include different types of power generation units that operate using different power generating technologies. A common type of power generation unit used in islanded electrical grids is a gas or other fuel burning turbine. During operation, fuel (e.g., gas) is injected into a turbine, the fuel ignites creating pressure differences which cause the turbine to move. Because injection of the fuel into a turbine causes rapid changes in the turbine speed, this type of power generator is able to respond quickly to changes in load demand. Of course, other types of power generating units used in electrical islanded grids may include diesel turbines, steam turbines and various types of green energy power sources, such as wind turbines, solar panels, etc.

In the case of fuel burning turbines and to some extent, steam turbines, the amount of fuel or steam injected into the turbine controls the speed of the turbine and the amount of power delivered by the prime mover of the turbine. When generating AC (alternating current) power, the rotational speed of the turbine controls the frequency of the AC power output by the turbine. Generally, turbines can be controlled to operate in two different modes, including an isochronous mode and a droop mode. In an isochronous mode, the turbine is operated to run at a constant rotational speed which means that the frequency of the output power signal is tightly controlled to a constant setpoint by governor valve. A change in load or demand results in more or less fuel being injected into the combustion unit to keep the rotational speed (and thus the output frequency) of the turbine constant. This is implemented by an internal fast speed control loop (not shown in the diagram) and this fast speed control happens before any slower secondary MW control becomes necessary. In particular, an increase in load demand results in more fuel (e.g., gas) being injected into the turbine so that the turbine can provide more power quickly to maintain a near constant rotational speed. Likewise, a decrease in load demand results in less fuel (e.g., gas) being injected into the turbine so that the turbine can provide less power to maintain a near constant rotational speed. To avoid system instability, for each power system that includes multiple generating units, usually only one gas turbine can be designated as an isochronous machine. Unfortunately, running a turbine in isochronous mode in a power generation system typically means that the turbine cannot generally be run at full capacity, as the turbine needs to have enough upper-side and down-side room to be able to increase or decrease the injection of fuel in response to changes in load demand. As a result, turbines operated in isochronous mode are not typically able to run at the most optimal fuel efficiency setting (which is typically full capacity).

On the other hand, when operated in droop mode, a turbine provides a particular output power and load demand changes result in the turbine running at different speeds while outputting real power (due to loose control implemented on the droop mode turbines). While operating a power generating unit in droop mode enables the power generating unit to run at optimal fuel efficiency (typically near full capacity), the output frequency of the unit changes in response to load demand changes. For example, as the load increases, the power generating unit runs at a lower speed, resulting in a lower output frequency and similarly, as the load decreases, the power generating unit runs at a higher speed resulting in a higher output frequency. Thus, in droop mode, the output power and frequency of a generator are inversely proportional. When frequency decreases, output power increases (because the load demand increases) and vice versa.

As noted above, the main difference between the droop and the isochronous control modes lies in their relationship to frequency. In isochronous mode, generators maintain a constant frequency, whereas use of the droop mode allows for changes in frequency in response to changes in load. Because the droop mode accommodates changes in frequency, it allows multiple generators to work in tandem by dividing loads across different generating units in proportion to their power capacity. Thus, droop mode is useful when employed in grids with multiple generators and when dealing with loads with higher degrees of variance.

However, problems can arise when a generator in droop control mode encounters a large load or a sudden load change. In particular, when a load is tripped in the system, the output frequency of the droop mode generators will reach a value above a nominal or desired value. If, on the other hand, a large generating unit on the grid shuts down, the frequency of the other power generating units will settle at a steady-state value below the nominal value. Both cases require secondary and tertiary frequency controllers or other control loops to return the frequency to its nominal and desired value.

On the other hand, the isochronous control mode is typically used when a generator either stands alone or is the largest unit on a grid. In this mode, the energy admitted to the prime mover is regulated very tightly in reaction to load changes, which, in droop control mode, would cause changes in frequency. In particular, because energy (fuel) is quickly supplied to the prime mover in the isochronous mode, the frequency of the power output by the generator remains constant. However, issues arise when multiple generators in isochronous mode are operating on the same grid (or parallel to each other) and the load changes. If all of the units are in isochronous mode, they will start competing to respond first. In the case of parallel generators, one generator will assume the entire load, while the other will receive none of it.

Because of the tradeoffs between the isochronous and droop modes, it is difficult to maintain tight frequency control within an islanded electrical grid while also providing for efficient power generation. Frequency control is important, however, as an AC power grid needs to maintain electrical power signals within the tight frequency range to protect the equipment connected to the grid.

Due to this complexity, the output frequency of a power generating plant within an islanded electrical grid is sometimes controlled manually. In this case, an operator watches a frequency display of the power plant, and when the operator sees that the output power frequency is outside of an allowable band or range, the operator manually adjusts the kilowatt (KW) output settings on the power generating units running within the power plant. In most cases, the power generating units are controlled by issuing raise/lower pulses which cause the generating units to raise or lower the output kilowatts by a particular amount, which results in a change in the frequency of the output power.

However, there are at least two known automatic frequency control methods that have been used to tightly control the frequency of the output power of a power plant including multiple generating units, such as a power plant providing power to an islanded electrical grid. The first automatic frequency control method designates a particular gas turbine generator within the power plant, typically the one with the largest capacity, as the isochronous machine and runs this machine in the isochronous mode. This isochronous machine is controlled (fuel input is raised and lowered) so as to hold the grid frequency in the preset range, while the rest of the power generating units in the network are used to control megawatt (MW) output individually (typically, in “droop” mode). In this case, the isochronous turbine controller runs very fast (e.g., at a 20 millisecond update rate) and constantly looks at the turbine speed. When the turbine speed deviates from a desired operating point such as 3600 rpm (for a 60 Hz system), the turbine controller automatically adjusts the load on the machine to keep the speed at 3600 rpm (and thus keep the frequency at 60 Hz). Additionally, this control system includes logic to automatically adjust the load of the other power generating machines in droop mode, so that the isochronous machine always has enough spare capacity to respond to a load change. This automatic frequency control scheme modulates frequency quickly upon upset (e.g., a load change) but the overall fuel usage suffers because the most efficient unit (usually the isochronous machine) is prohibited from operating at full load, thus reducing the efficiency of the overall power generating scheme. In the overall strategy, the load distribution among the droop units can be either determined by some particular preset logic or can be determined by an optimization program designed to achieve partial power generation optimization among the droop units, without considering the isochronous machine.

The second popular automatic frequency control method utilizes a feedback controller, usually a proportional-integral-derivative (PID) type controller, to control output frequency. In this case, the PID type controller may use a minimum cost objective optimization routine to simultaneously adjust the output power level of all of the generating units within the power generating plant or network so that the load demand is distributed among all of the power generating units in the most economic manner. However, the frequency control response promptness is compromised due to the secondary nature of the PID type control loop, and thus this technique provides inferior frequency control, especially during rapid load changes within the power grid.

### SUMMARY

A new control scheme or technique for use in, for example, islanded power grids or power plants, provides for better power generation optimization by enabling the most efficient power generating units (typically the largest generating units with the most generating capacity) to operate at the maximum or most optimal output point for most of the time while enabling these same units to operate as an isochronous machine during periods of high load demand change. This technique strikes a balance between the two frequency control methods described above for islanded electrical grids, as this technique includes both frequency control promptness (as it does not use an extra PID type control loop to control frequency at a secondary level) and overall fuel efficiency by dynamically designating an isochronous machine based on a total load demand prediction.

Generally, according to this new control technique, when the load demand is not expected to change much, large capacity machines within the power generating plant (which are typically the most efficient) run at full or most optimal load and a smaller (typically less efficient) machine can be operated in the isochronous mode to control frequency on the grid. When high or excessive load variation is expected, a large power generating machine can be put back into isochronous mode to provide for better or faster frequency control during this period of large load demand changes.

In some embodiments, the techniques described herein relate to a method of controlling a set of power generating units supplying power to an electrical grid, including: determining, based on a predicted load demand over a near-term time horizon, one of the set of power generating units to operate in an isochronous mode; operating the one of the set of power generating units in the isochronous mode to provide power to the electrical grid while performing frequency control on the electrical grid; and operating other ones of the set of power generating units in a droop mode to provide additional power to the electrical grid.

The techniques described herein may also relate to a method wherein determining the one of the set of power generating units to operate in the isochronous mode includes; implementing an optimization procedure that determines an optimal operating point for each of the set of power generating units based on overall power generating efficiency, and selecting the one of the set of power generating units to operate in the isochronous mode as the largest capacity power generating unit that, when run at its associated optimal operating point, has a needed power output movement reserve to be able to control frequency on the power grid based on an expected change in the load demand during the near-term time horizon.

The optimization procedure may include an optimization objective function that uses a set of weights for the power generating units to determine the optimal operating point for each of the power generating units, wherein the set of weights is established to weigh a higher capacity power generating unit more than a lower capacity generating unit when a larger load demand change is expected during the near-term time horizon. The method may include generating a load demand prediction over a period of time based on historical load demand data and generating the load demand prediction may include creating a load demand prediction model based on the historical load demand data and using the load demand prediction model to generate the load demand prediction. The load demand prediction model may be a neural network model, for example.

The control method may include repeating the steps of (1) determining, based on a predicted load demand over a near-term time horizon, one of the set of power generating units to operate in isochronous mode, (2) operating the one of the set of power generating units in the isochronous mode to provide power to the electrical grid while performing frequency control on the electrical grid, and (3) operating the other ones of the set of power generating units in droop mode to provide additional power to the electrical grid at each of a plurality of different cycle times with each different cycle time having an associated near-term time horizon. The cycle times may be, for example, any desired time period, such as a second, a minute, or an hour.

Each of the power generating units may be a fuel burning power generating unit. However, in some cases, two or more of the power generating units may include a battery energy storage system (BESS) that stores energy from a green energy source, such as a wind turbine or a photovoltaic solar cell. Here, running one of the two or more power generating units that includes a BESS in the isochronous mode may include operating the BESS of the one of the two or more power generating units as a master unit using a voltage controlled inverter and may include running the other of the two or more power generating units that includes a BESS in the droop mode by operating the BESS of the other of the two or more power generating units in a slave mode using a current controlled inverter.

In some embodiments, the techniques described herein relate to a power generating system for providing power to an electrical grid having an electrical distribution network, the power generating system including: a plurality of power generating units coupled to the electrical distribution network; and a control system coupled to each of the plurality of power generators. In this case, the control system may include a routine that executes on a computer processor to determine, at each of a multiplicity of cycle times, based on a predicted load demand over a near-term time horizon, one of the plurality of power generating units to operate in an isochronous mode; a first controller element that operates the determined one of the plurality of power generating units in the isochronous mode during a particular cycle time to provide power to the electrical grid while performing frequency control on the electrical grid; and a second controller element that operates other ones of the plurality of power generating units in a droop mode during the particular cycle time to provide additional power to the electrical grid.

In other embodiments, the techniques described herein relate to a controller for controlling a set of power generating units supplying power to an electrical grid, including: a first routine, stored on a computer memory and executable on a processor, to determine during each of a plurality of cycle times and based on a predicted load demand over a near-term time horizon, one of the set of power generating units to operate in isochronous mode during a particular cycle time; a first control routine, stored on a computer memory and executable on a processor, to operate the one of the set of power generating units in the particular cycle time in the isochronous mode to provide power to the electrical grid while performing frequency control on the electrical grid; and a second control routine, stored on a computer memory and executable on a processor, to operate other ones of the set of power generating units in droop mode to provide additional power to the electrical grid.

### BRIEF DESCRIPTION OF THE DRAWINGS

FIG. 1 is a diagram of an example power generating and delivery network, such as that of an islanded power grid, which uses the power generating control method described herein.

FIG. 2 is a flow chart of an example optimization procedure that may be used to generate an optimization routine and various coefficients used in the power generating control method described herein.

FIG. 3 is a flow chart of an on-line control and optimization routine that may be used in the power generating control method described herein.

FIG. 4 is a table of power generating unit coefficients and parameters associated with an example set of power generating units associated with an example power generating system using the power generating control method described herein.

FIG. 5 is a graph depicting the relationship between fuel flow and load for each of the example power generating units of FIG. 4.

FIG. 6 is a graph of an example load demand profile generated in an example implementation of an example power generating system using the power generating control method described herein.

FIG. 7 is a graph depicting an example isochronous capacity versus expected load demand curve used in an example power generating system described herein.

FIG. 8 is a table listing optimization weighting parameters determined for each of the set of power generating units over a 24 hour period of the example power generating system implementation using the power generating control method described herein.

FIG. 9 is a table listing an optimized load distribution and designated isochronous power generating unit over a 24 hour period for each of the set of power generating units of the example power generating system implementation using the power generating control method described herein.

### DETAILED DESCRIPTION

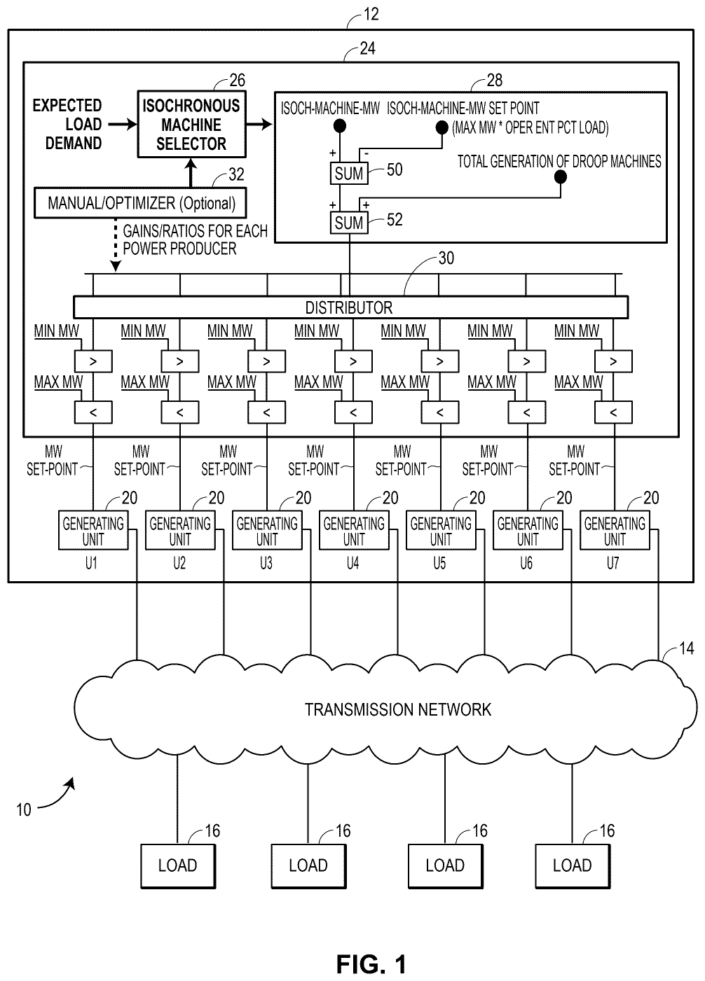

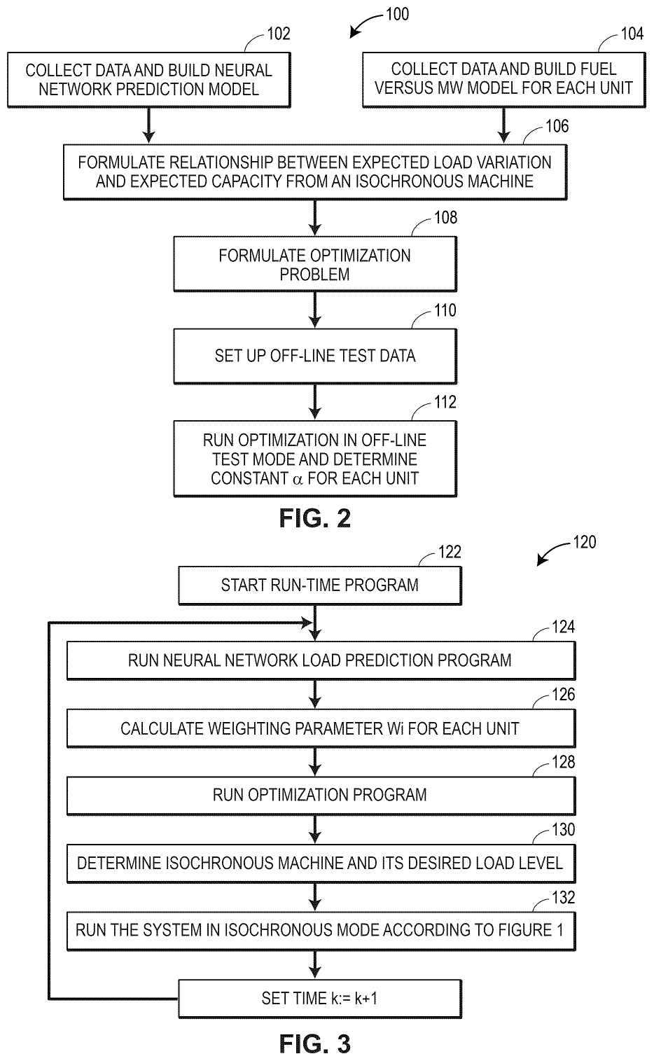

FIG. 1 depicts an example islanded power grid 10 including a power generating plant 12 connected through electrical transmission lines or networks 14 to one or more loads 16 which consume electricity or power provided via the power grid 10. In this example, the power generating plant 12 includes various power generating units 20 connected to and controlled by a control unit 24. The control unit 24, which may be implemented as one or more control routines stored in a computer memory and executed on a computer processor, includes an isochronous machine selector and set point setting unit 26, which selects the identity of and sets operational parameters for one of the power generating units 20 which will be operated in an isochronous mode at any particular time. The control unit 24 also includes and a power control circuit 28 which determines the power generation of various ones of the power generating units 20 which will be operated in either isochronous mode or droop mode to provide the total power output by the grid 10 at any particular time. The control unit 24 also includes a distributor 30 and a control management routine or section 32 which preferably includes an optimizer, but which may be operated manually. The control management routine or section 32 in conjunction with the isochronous machine selector 26 generally determines which of the power generating units 20 will be operated as the isochronous machine at any particular time (that is, during any particular cycle time of the control unit 24) and may indicate or determine the operational setpoints of each of the power generating units 20 at all times during operation of the plant 12 based on an expected load demand.

While the power generating units 20 are described herein generally as being gas turbine power generators, one or more of the power generating units of the plant 12 could be other types of power generators, including for example, diesel or steam turbine generators. Moreover, in some cases, the plant 12 may include one or more electrical power batteries or storage units that are charged, partially or wholly, by green energy sources, such as wind turbines, solar panels (photovoltaic cells), etc. Moreover, while the power generators 20 of FIG. 1 are illustrated as being within a single power plant 12, the power generators 20 could be disposed at various different locations within the islanded power grid 10, including at various different power plants, at various different commercial or residential locations, etc., as long as these units are connected to and controlled by the control system or controller 24.

Generally speaking, the control system 24 operates to determine, at any particular time, the identity of one of the power generating units 20 that will be operated in isochronous mode and will then operate this power generating unit in isochronous mode to control the frequency of the power signal on the power grid, and will operate the others of the power generating units 20 in droop mode to provide additional real power on the power grid. The controller 24 will generally select the power generating unit that is to run in isochronous mode based on an expected load demand (and more particularly based on an expected load demand change) over a preset period of time in the future, referred to herein as a near-term time horizon. When the controller 24 determines which power generating unit 20 will be operated in the isochronous mode, or as part of that determination, the controller 24 may determine or establish a power or operating setpoint for that unit which may also be dependent on the expected change in the load demand, as that set point needs to enable the isochronous machine or unit 20 to be able to respond quickly to load demand changes to keep the frequency of the power signal on the grid or transmission network 14 within a desired or preset range. This typically means that the isochronous machine 20 will be operated at less than full or near full capacity, to enable the isochronous machine to be able to increase power or to decrease power (fuel input) as needed to control the output frequency. In particular, this isochronous machine needs to be operated at a set point that enables it to have a needed or sufficient power output movement reserve (up or down) to maintain a desired output frequency on the transmission network 14 in light of the expected change in load demand.

In one embodiment, as illustrated in FIG. 1, the power control circuit 28 controls the isochronous machine (which may change from time to time) and includes a summer 50 which subtracts a preset value or factor, which may be computed as the maximum power (MW) capacity of the isochronous machine multiplied by a percentage (e.g., 75 percent) to determine the initial MW operating point of the isochronous machine. The preset percentage may be entered by an operator or established in any other desired manner.

Moreover, the power control circuit 28 determines the total power to be provided to the grid as the sum of the power provided by the droop mode machines and the isochronous machine as indicated by the summer 52 This total power determination is then provided to the distributor 30 which distributes the power generating operation between the various power generating units 20 according to set points or operating points established for each of the droop mode machines. The distributor 30 can use manual inputs from, for example, an operator input via the unit 32 to determine the operating points of the droop mode machines. However, preferably, the unit 32 includes an optimizer, such as the optimizer described below, to determine and set the operating points of each of the isochronous and the droop mode machines, so as to optimize (e.g., minimize) total fuel consumption or operating costs within the power generation system given the operation of the isochronous machine currently selected.

Importantly, the controller 24 operates on-line or in real time to determine the particular power generating unit 20 to operate in the isochronous mode at any particular time, and may select a different power generating unit 20 to operate in the isochronous mode at different times based on changes in the expected load demand within the near-term time horizon. Moreover, the optimizer within the unit 32 operates to optimize the system based on the current load demand and may be configured to select the power generating unit that is to operate in isochronous mode based on an optimization technique such as that described herein.

In any event, using this control system or technique, different ones of the power generating units 20 may be selected as the isochronous machine at different times based on the expected load or load change on the power grid 10, so that a high capacity machine 20 can be used as the isochronous machine during times at which large changes in load are expected and lower capacity power generating units 20 can be selected as the isochronous machine when lesser load demand changes (and thus smaller frequency upsets) are expected. This feature enables the larger capacity power generating units (which are typically more efficient and economical) to run at higher capacities during times at which lower load demand changes are expected, leading to a more optimal or efficient overall power generation system.

In particular, the control system methodology described herein strikes a balance between the two known existing frequency control methods described above for an islanded electrical grid. This new framework accounts for both frequency control promptness and overall fuel cost economics by dynamically designating an isochronous machine based on a total load demand prediction over a particular time horizon. When the load demand is not expected to change very much, large capacity power generating machines on the power grid may run at full load (or some other optimal setting) and a smaller power generating machine can be used in an isochronous mode to perform frequency control. When higher or more excessive load variation is expected within the time horizon, a larger machine can be put back in isochronous mode so that the isochronous machine has enough power output movement reserve to be able to control frequency during the higher load demand changes. When the isochronous unit is determined, the control system uses the isochronous machine to perform frequency control and will, at least in some embodiments, attempt to optimize total power generation using the other machines in droop mode. In still other cases, the controller 24 may perform an optimization routine that distributes power generation among the power generating units 20 in a manner that optimizes the overall performance or efficiency of the entire system and may then choose the isochronous machine as the machine that is best capable of controlling frequency in the power grid 10 under the optimized configuration. Typically, this machine will be the largest capacity machine that has sufficient power output movement reserve to robustly control frequency in response to expected load demand changes over the near-term time horizon.

In one embodiment, a prediction of load demand over a time horizon is determined and is used by the control system 24, and in particular by the optimizer 32 therein, to perform optimized control. The predicted load demand may be determined from and based on historical load demand and other data over time, on a user input or prediction or based on one or more models. As an example, a neural network based load demand prediction model may be constructed based on available historical data regarding load demand on the islanded power grid to produce a prediction of load demand over a time horizon. The output variable of the neural network model is the predicted electrical load demand over a short or near-term time horizon in the future, i.e., the time horizon. The input variables of the neural network model may include, but are not limited to, historical load, historical temperature, historical day type, current day type, current temperature, and short-term forecasted temperature. Such a neural network model may produce real time predictions of future load demand based on the current set of input variables.

FIG. 2 illustrates a flow chart 100 of an example method of setting up an optimization for use in a control system for a power generating system, wherein the control system determines an optimized operational point for each of the power generating units in the power generating system and determines which one of the power generating units will operate as the isochronous machine at any particular time, based on an expected load demand prediction (e.g., load demand change) over a near-term time horizon. In particular, at a block 102, a user or the system may collect measurements of actual load demand within the islanded electrical grid over time (e.g., for a day, a week, a month, etc.) and indications of one or more input variables for the model, e.g., day of week, time of day, outside temperature, etc. The block 102 may then construct a load demand prediction curve or model based on this data. As noted above, in one example, the block 102 may construct a neural network model that predicts a load demand over a particular near-term time horizon.

Additionally, at a block 104, a user or the system may collect data and build a fuel use versus power (MW) output for each power generating units (the units 20 of FIG. 1) in the power generating system to build an operational model for each power generating unit. This model may be provided by a power generating unit manufacturer in some instances.

Next, at a block 106, the system may formulate a relationship between the expected load variation and the expected capacity from an isochronous machine to perform frequency control given a particular load demand. This relationship may be, for example, a linear or a non-linear relationship defining the capacity of an isochronous machine needed for any particular load demand (or load demand change) to perform desired or adequate frequency control at that load demand.

At a block 108, the user or the system may formulate the optimization routine or problem, i.e., the optimization construct including an objective function to be used in the optimization with various constants not yet determined. At a block 110, the system or a user may set up or run off-line tests to collect off=line data including, for example, actual operational data for each power generating unit. At a block 112, the system may run an optimization in off-line mode on the off-line test data and may iterate to determine the best values for the constants to be used in the objective function.

FIG. 3 illustrates a flow chart 120 that may be used during run-time of the control system 24 (and in particular, the optimizer 32) of FIG. 1 to perform optimized control of the power generating units 20. In particular, at a block 122 the run-time optimizer starts. At a block 124, the optimizer runs the neural network load prediction model (based on current input variable values) to determine a predicted load demand over the near-term time horizon. Of course, the block 124 could use other types of models or use a load demand prediction curve generated in other manners to obtain a load prediction over the time horizon. In some cases, a user or operator may provide a load demand prediction.

In this example, however, when running in real-time, the neural network model predicts the total power (MW) demand on the islanded power grid in a forward-looking short time window. The difference between the predicted total load demand and the current load level (i.e., the expected load demand change over the near-term time horizon) becomes the indicator for a short term load fluctuation which is a reflection of frequency fluctuation. This expected frequency fluctuation can be incorporated into an optimization objective function used by an optimizer in such a way that selection of the larger capacity power generating units are penalized for given short term load variations.

In any event, a block 126 calculates a set of weighting parameters Wi for each of the power generating units (in, for example, a manner described below), where the total number of power generating units is n. Next, a block 128 runs the optimization problem using the current weights Wi (for i=1 to n) and the predicted load demand to determine the optimized operational set points of each of the power generating units 20. A block 130 then determines the isochronous machine to use during the next cycle or cycle time as the machine or unit 20 that has the highest capacity that has the needed upward and downward power output reserve for making expected control movements during the next cycle. A block 132 then operates the power generation system by operating the designated isochronous machine in the isochronous mode and operating the other power generating units in the droop mode, with the isochronous machine and the droop machines each being controlled to operate at the set points or operating points determined by the optimization routine. Finally, a block 134 increases the time k to the next time k+1 (i.e., to the next cycle time) and the system repeats the blocks (steps) 124 to 132 for the next operation cycle or cycle time. The cycle time k may be any desired time, such as once per millisecond, once per second, once per minute, once per hour or any other time or rate.

As a further explanation of the optimization routine, an example optimization procedure will be described below, it being understood that other optimization procedures could be used instead. In this example, it will be assumed that there are n power generating units in the network, which are generically denoted as G1, G2, . . . , Gn. The generating load or capacity (in terms of MW) for each power generating unit is represented as P1, P2, . . . , Pn. Without loss of generality, the example optimization routine assigns the unit numbers to individual power generating units so that the unit maximum capacity is smaller in the ascending order of the unit number, i.e. P1,max≥P2,max≥ . . . ≥ Pn,max. Moreover, the minimum and maximum load for each generating unit Gn is defined as P_{i,min} and P_{i,max} (1≤i≤n). In addition, the minimum and maximum fuel flow for each unit Gn is designated as F_{i,min} and F_{i,max} (1≤i≤n) respectively.

Now, at any given time instant or cycle k in real-time operation, the total load level or load demand is Lₖ and the short-term predicted total load demand is \tilde{L}ₖ. The absolute value of load change expectation Dₖ in the short term (over the near-term time horizon) is simply calculated as:

$${D}_{k} = abs ( {L}_{k} - {\tilde{L}}_{k} ) \qquad ( 1 )$$

Furthermore, an approximate relationship between expected load variation and expected unit capacity from an isochronous machine is developed (at, for example, the block 106 of FIG. 2). In order to stabilize frequency control, a larger load variation (expected load demand change) will generally require a larger capacity unit to be designated as the isochronous machine to provide sufficient power output movement reserve for the isochronous machine. The relationship can be a simple linear function (one-to-one mapping) or can be a nonlinear function. For example, in the linear relationship case:

$$Le = K * {D}_{k} \qquad ( 2 )$$

wherein Le is the expected isochronous unit capacity and K is a constant.

Furthermore, a load weighting selecting factor at the time k for each power generating unit i, Cᵢ(k), can be defined as:

$${C}_{i} ( k ) = \{ \begin{matrix}1 & if \vert {P}_{i , max} - Le \vert \leq S \\ 0 & otherwise\end{matrix} ( 1 \leq i \leq n ) \qquad ( 3 )$$

wherein S is a fixed threshold value.

Then the weighting factor for unit i, Wi, in the optimization cost function at a time k can be defined as:

$$Wi = 1 + α * {C}_{i} ( k ) * ( Pi , max - Pn , max ) / ( P 1 , max ) \qquad ( 4 )$$

wherein α is a tuning constant which can be adjusted and finalized offline before the real-time operation (for example, at the block 112 of FIG. 2). Generally, there is no need to perform further on-line adjustment on the constant α. However, the constant α can be designed differently for each unit.

Next, the weighting factor Wi is multiplied by the fuel usage Fᵢ (either amount or cost) of a corresponding unit and, based on the manner in which the weighting function is formulated, a larger capacity unit will be weighted more in the cost function than a smaller one.

In particular, at each sampling or cycle time k, the optimization problem (i.e., objective function) can be formulated as follows:

$$Minimize {\sum }_{i = 0}^{n} {W}_{i} \cdot {F}_{i}$$

subject to the constraints:

$${\sum }_{i = 0}^{n} {P}_{i} = {L}_{k} \qquad ( 5 )$$

$${P}_{i , min} \leq {P}_{i} \leq {P}_{i , max} ( 1 \leq i \leq n ) \qquad ( 6 )$$

$${P}_{i} = {MVA}_{i} \cdot {PF}_{i} \qquad ( 7 )$$

$${MVA}_{i} = {a}_{i} \cdot {μ}_{i} \cdot {ρ}_{i} \cdot {h}_{i} + {b}_{i} \qquad ( 8 )$$

$${h}_{i} = {F}_{i} \cdot H \qquad ( 9 )$$

wherein:
   MVA is unit mega voltage-ampere;
   PF is unit power factor;
   aᵢ and bᵢ are coefficients used to characterize linear relationships between the heat input and MVA output in unit i;
   μᵢ is a unit(i) kilo-hour efficiency correction factor;
   ρᵢ is unit(i) compressor inlet temperature correction factor;
   hᵢ is unit(i) heat input generated from fuel combustion;
   Fᵢ is the fuel flow for unit(i); and
   H is the heating value of fuel, assumed to be the same for all units.

This optimization formulation implicitly allows the user to specify the trade-off between overall system efficiency and the responsiveness of the desired frequency regulation, i.e., how much efficiency the user is willing to give up in return for more stable frequency regulation, based on the selection of the value of S and alpha (α).

By solving this optimization problem described above (which can be performed in the optimizer 32 of FIG. 1), the minimum cost-based optimization tends to drive the operating point of a larger power generating unit to a point that is less than full capacity when a significant load demand change is expected in the near future. Conversely, larger units will tend to be assigned to full capacity when a steady load demand is expected in the near future. When this optimization is successfully solved at each computational cycle or cycle time k, the largest machine with extra remaining capacity (sufficient to meet the expected power deviation to control the frequency of the output power in the near-term time horizon) can be chosen as the near-term isochronous machine. This machine will be driven to the calculated desired level in anticipation of predicted frequency variation. Of course, this optimization procedure runs continuously in real-time at each scheduled interval k, which means that the identity and set point of the isochronous machine can change at any time (computational cycle) based on the change in the load demand in the near-term time horizon.

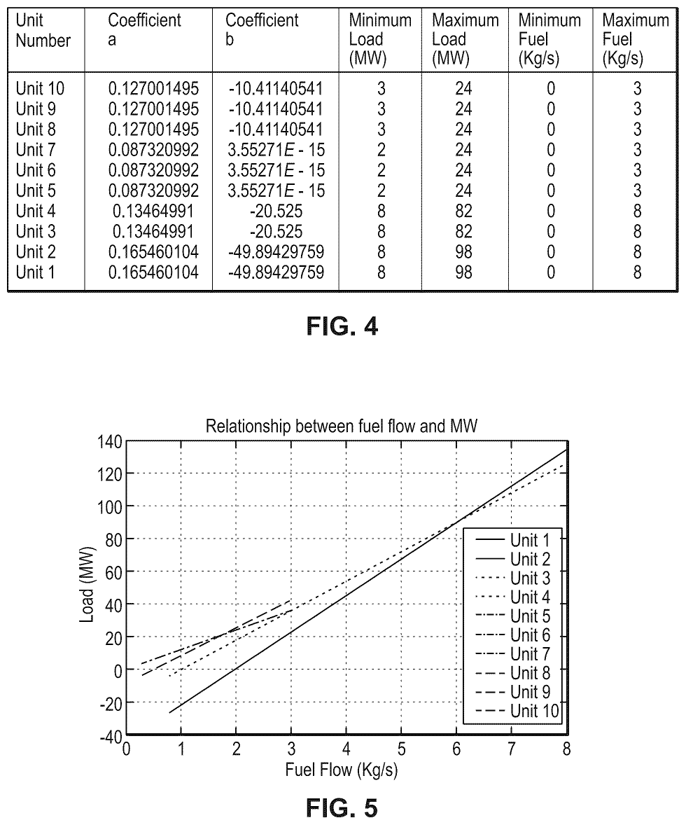

A numerical example of this control concept will be discussed with respect to FIGS. 4-9. In this example, ten gas turbine units are assumed to be disposed in an islanded electrical network and, in this case, the load and heat input relationship is represented by equations (8) and (9) above. Moreover, the table of FIG. 4 lists the parameters of the generators in the system (including the a and b coefficients determined at the block 112 of FIG. 2) while FIG. 5 is a chart depicting an assumed relationship between load and fuel flow for each of the ten units, as listed in FIG. 4. As will be understood in this example, unit-1 and unit-2 are essentially the same type of units with the same characteristics, unit-3 and unit-4 are essentially the same, unit-5, unit-6 and unit-7 are essentially the same, and unit-8, unit-9 and unit 10 are essentially the same, with unit-1 (and unit-2) being the largest (capacity) power generating units and with unit-8, unit-9 and unit-10 being the smallest power generating units.

In this example, and without loss of generality, it is assumed that the kilo-hour usage correction factor and temperature correction factors are all 1, the power factors for all of the generators are set as 0.9; fuel heating values are chosen to be 41600 KJ/Kg for all units; and a tuning parameter α=0.5 is selected for all isochronous machine candidates.

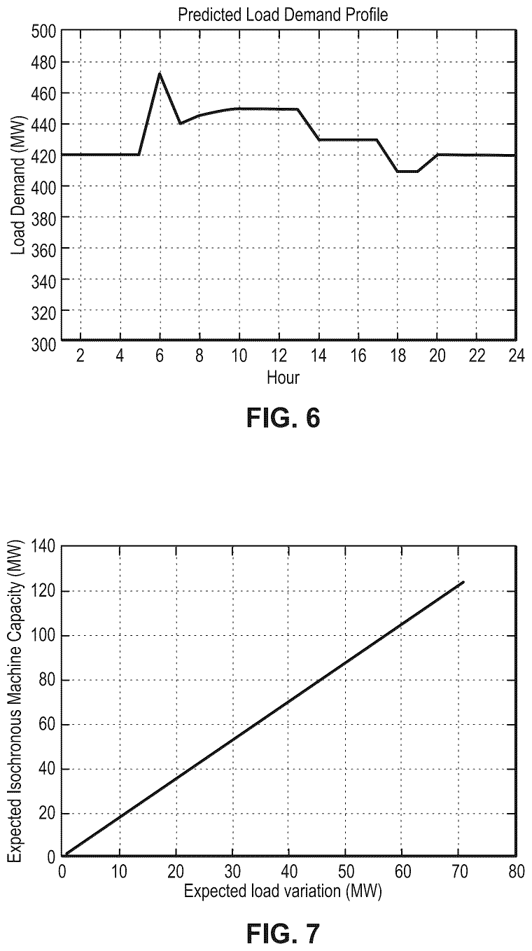

Furthermore, in this example, the load demand profile (generated by a neural network prediction program, for example), is depicted by FIG. 6, in which the largest load changes are expected between the hours 5 and 6, and the hours 6 and 7, and with less significant but still large load changes being expected between the hours 13 and 14, between the hours 17 and 18 and between the hours 19 and 20.

In this case, the power generating units 1, 3 and 5-10 are selected as isochronous machine candidates at any time and the load variation mapping relationship defining the expected load variation versus the expected isochronous machine capacity (equation 2) is illustrated in FIG. 7 as a linear relationship. However, the load variation relationship could be non-linear.

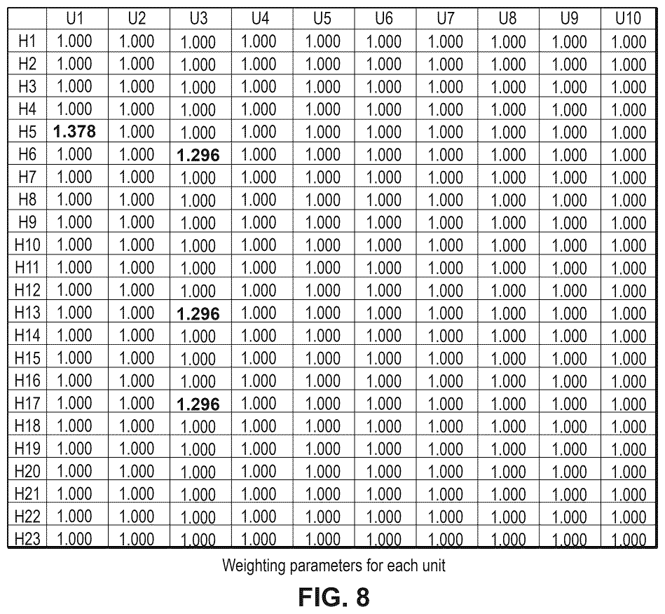

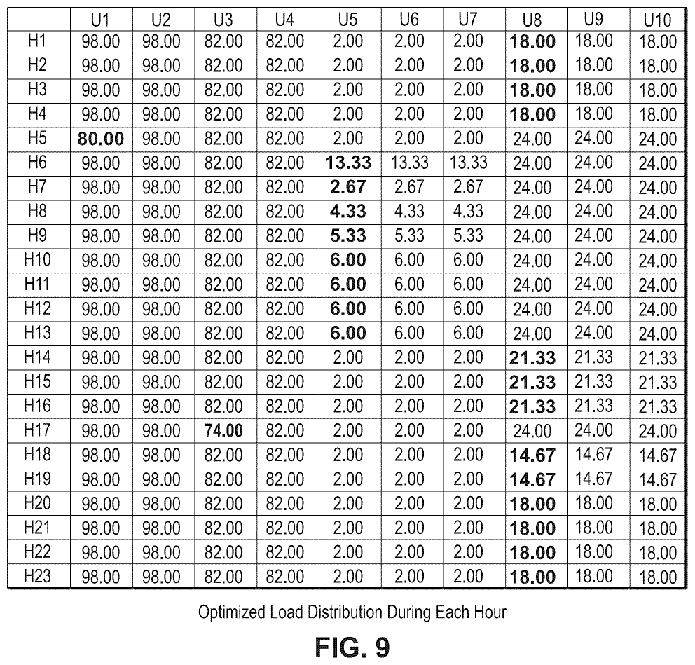

The tables of FIGS. 8 and 9 illustrate the results of implementing the optimization routine in the example defined above (e.g., using the procedures of FIGS. 2 and 3). In particular, the table of FIG. 8 lists the weighting parameters Wi for all of the power generating units determined by the optimization routine during each hour based on the implementation of equations (3) and (4). Moreover, the table of FIG. 9 lists the optimized load distribution between the power generating units during each hour of operation. As illustrated in the table of FIG. 8, unit 1 is weighted higher at hour 5, while unit 3 is weighted higher at hours 6, 13, and 17. This weighting in the objective function represents an economic penalty that one is willing to accept for the sake of better frequency control. Also, as seen from the table of FIG. 9, unit-1 is moved away from full load at hour 5 and unit 3 is moved away from full load at hour-17 in anticipation of the large load demand swings predicted at these times. However, at hours 6 and 13, both unit-1 and unit-3 stay at full-load despite anticipated load demand variation and penalty weighting in the optimization cost function. This means, based on the system setup, the efficiency of the overall system operation weighs over the frequency regulation concern at these hours. The bolded numbers in the table of FIG. 9 illustrate which of the power generating units is selected as the isochronous machine for each hour based on the optimization criterion. In particular, the isochronous machine selection during each hour goes to the highest capacity machine that has the needed upward and downward power output movement reserve for making the expected control movements during the hour. Thus, as illustrated in FIG. 9, unit-8 (a smaller capacity machine) is selected as the isochronous machine during hours 1-4 (when very little load demand change is expected), unit-1 is selected as the isochronous machine during hour 5 (where high load demand change is expected), unit-5 is selected as the isochronous machine during hours 6-13, unit-8 is selected as the isochronous machine during hours 14-16, unit-3 is selected as the isochronous machine during hour 17, and unit-8 is selected as the isochronous machine during hours 18-23. It is significant that, in this case, the lowest capacity machine (unit 8) is selected as the isochronous machine during most of the operational time, while the higher capacity machines (unit-1 and unit-3) are selected as the isochronous machine only during certain periods of high or larger expected load demand changes and are thus able to run at higher capacity (and therefore more overall efficiency) during other times. This operation leads to better overall efficiency of the power generating system while still enabling robust frequency control when needed.

As will be understood, the example system discussed above uses an optimization routine to find the optimal generator to use as the isochronous generator in an electrical islanded power grid which includes only fossil-fuel fired generators (e.g., diesel or gas generators). However, many islanded electrical networks (also known as “microgrids”) also contain considerable amount of renewable energy sources such as solar photovoltaic (PV) panels and wind turbines. These renewable energy sources are inverter-based and they normally operate in droop mode, which means a frequency-watt control curve is used to control the frequency by changing the active power output of the inverter. Also, when renewable energy sources are installed, some form of energy storage device, such as a battery energy storage system (BESS), is often present to help supply or absorb power whenever needed.

In an islanded electrical network setting, if the renewable energy source penetration is minor compared to conventional fossil fuel based generating sources, then the above described control system can be used to control the operation of the power generating units so long as multiple conventional generators dominate the usage. In this case, the isochronous machine can be determined as outlined above, and rest of the machines (including inverter based renewable sources) can operate in frequency-following manner (e.g., droop mode).

In another case, in which renewable energy sources dominate the islanded grid, a BESS with an embedded frequency-watt control curve in the inverter usually plays a role in forming the grid. In recent years, with the reduction of the capital cost of batteries, BESS technologies have become an attractive choice for various grid-support applications. Among these applications, frequency support has been suggested as being possible due to the fast response and high ramp rate of a BESS. Specifically, if the BESS has a voltage source inverter (VSI) that can be placed in master mode, it can be used to hold the frequency of the island like an isochronous generator. The master/slave control method uses a voltage-controlled inverter as a master unit and current-controlled inverters as the slave units. The master unit maintains the output voltage sinusoidal, and generates proper current commands for the slave units. When the inverter is in master mode for a 60 Hz system, it will convert DC power to AC power 60 times per second and the battery will discharge when load demand exceeds current generation and charge when current generation exceeds the load demand. Any other battery inverters on the network would be in slave mode and follow the frequency of the Master, similar to generators in droop mode. (As a result, this operation is described herein as being droop mode control.) In general, the master battery that anchors the frequency regulation should have its charge level roughly placed in the middle (e.g., 50% to 60%) of the entire operating range. In this manner, the battery has the flexibility to either charge or discharge based on frequency regulation needs. On the other hand, the utility industry often has battery charge level dispatched as set-points on an hourly basis. This hourly schedule is usually determined daily by an optimal planning/scheduling algorithm which minimizes an overall cost objective function or achieves overall maximum operating efficiency. For example, if an extremely hot day is predicted in a future 24-hour window, the electricity usage (and also price) will be expected to be very high. It is economically beneficial to charge batteries near full capacity the night before. Conversely, the opposite scenario may lead to lower charge levels for those batteries. Because the size of the batteries may be different and the most efficient operating range may not always be the most adequate range for anchoring the frequency (in master mode), an optimization routine can be implemented to optimally determine which battery to serve as the master unit during runtime operations. This optimization routine can be performed or configured in a manner that is similar to the approach described above for fossil-fuel based generators.

When implemented in software, any of the process control and optimization software described herein may be stored in any computer readable memory such as on a magnetic disk, a laser disk, or other storage medium, in a RAM or ROM of a computer or processor, etc. Likewise, this software or these routine may be delivered to a user, a process plant or an operator workstation using any known or desired delivery method including, for example, on a computer readable disk or other transportable computer storage mechanism or over a communication channel such as a telephone line, the Internet, the World Wide Web, any other local area network or wide area network, etc. (which delivery is viewed as being the same as or interchangeable with providing such software via a transportable storage medium). Furthermore, this software may be provided directly without modulation or encryption or may be modulated and/or encrypted using any suitable modulation carrier wave and/or encryption technique before being transmitted over a communication channel.

Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

1. A method of controlling a set of power generating units supplying power to an electrical grid, comprising:
determining, based on a predicted load demand over a near-term time horizon, one of the set of power generating units to operate in an isochronous mode;
operating the one of the set of power generating units in the isochronous mode to provide power to the electrical grid while performing frequency control on the electrical grid; and
operating other ones of the set of power generating units in a droop mode to provide additional power to the electrical grid.

2. The method of controlling a set of power generating units of claim 1, wherein determining the one of the set of power generating units to operate in the isochronous mode includes;
implementing an optimization procedure that determines an optimal operating point for each of the set of power generating units based on overall power generating efficiency, and
selecting the one of the set of power generating units to operate in the isochronous mode as the largest capacity power generating unit that, when run at its associated optimal operating point, has a needed power output movement reserve to be able to control frequency on the power grid based on an expected change in the load demand during the near-term time horizon.

3. The method of controlling a set of power generating units of claim 2, wherein the optimization procedure includes an optimization objective function that uses a set of weights for the power generating units to determine the optimal operating point for each of the power generating units, and wherein the set of weights are established to weigh a higher capacity power generating unit more than a lower capacity generating unit when a larger load demand change is expected during the near-term time horizon.

4. The method of controlling a set of power generating units of claim 1, further including generating a load demand prediction over a period of time based on historical load demand data.

5. The method of controlling a set of power generating units of claim 4, wherein generating the load demand prediction includes creating a load demand prediction model based on the historical load demand data and using the load demand prediction model to generate the load demand prediction.

6. The method of controlling a set of power generating units of claim 5, wherein the load demand prediction model is a neural network model.

7. The method of controlling a set of power generating units of claim 1, further including repeating the steps of (1) determining, based on a predicted load demand over a near-term time horizon, one of the set of power generating units to operate in isochronous mode, (2) operating the one of the set of power generating units in the isochronous mode to provide power to the electrical grid while performing frequency control on the electrical grid, and (3) operating the other ones of the set of power generating units in droop mode to provide additional power to the electrical grid at each of a plurality of different cycle times with each different cycle time having an associated near-term time horizon.

8. The method of controlling a set of power generating units of claim 7, wherein the cycle time is one of a second, a minute, or an hour.

9. The method of controlling a set of power generating units of claim 1, wherein each of the power generating units is a fuel burning power generating unit.

10. The method of controlling a set of power generating units of claim 1, wherein two or more of the power generating units includes a battery energy storage system (BESS), and wherein running one of the two or more power generating units that includes a BESS in the isochronous mode includes operating the BESS of the one of the two or more power generating units as a master unit using a voltage controlled inverter and wherein running the other of the two or more power generating units that includes a BESS in the droop mode includes operating the BESS of the other of the two or more power generating units in a slave mode using a current controlled inverter.

11. A power generating system for providing power to an electrical grid having an electrical distribution network, the power generating system comprising:
a plurality of power generating units coupled to the electrical distribution network; and
a control system coupled to each of the plurality of power generators, the control system including;
a routine that executes on a computer processor to determine, at each of a multiplicity of cycle times, based on a predicted load demand over a near-term time horizon, one of the plurality of power generating units to operate in an isochronous mode;
a first controller element that operates the determined one of the plurality of power generating units in the isochronous mode during a particular cycle time to provide power to the electrical grid while performing frequency control on the electrical grid; and
a second controller element that operates other ones of the plurality of power generating units in a droop mode during the particular cycle time to provide additional power to the electrical grid.

12. The power generating system of claim 11, wherein the routine includes an optimizer that implements an optimization procedure that determines an optimal operating point for each of the plurality of power generating units based on overall power generating efficiency, and wherein the routine selects the one of the plurality of power generating units to operate in the isochronous mode as the largest capacity power generating unit that, when run at its associated optimal operating point, has a needed power output movement reserve to be able to control frequency on the power grid based on an expected change in the load demand over the near-term time horizon.

13. The power generating system of claim 12, wherein the optimization procedure includes an objective function that uses a set of weights for the power generating units to determine the optimal operating point for each of the power generating units, and wherein the set of weights are established to weigh a higher capacity power generating unit more than a lower capacity power generating unit when a larger load demand change is expected during the near-term time horizon.

14. The power generating system of claim 11, wherein the routine determines a load demand prediction over the near-term time horizon based on historical load demand data.

15. The power generating system of claim 14, wherein the routine includes a load demand prediction model created based on the historical data and uses the load demand prediction model to generate a load demand prediction over the near-term time horizon during each time cycle.

16. The power generating system of claim 15, wherein the load demand prediction model is a neural network model.

17. The power generating system of claim 11, wherein each of the power generating units is a fuel burning power generating unit.

18. The power generating system of claim 11, wherein two or more of the power generating units includes a battery energy storage system (BESS), and wherein when the first controller element runs one of the two or more power generating units that includes a BESS in the isochronous mode, the first controller element operates the BESS of the one of the two or more power generating units as a master unit using a voltage controlled inverter and wherein the second controller element runs the other of the two or more power generating units that include a BESS in the droop mode by operating the BESS of the other of the two or more power generating units in a slave mode using a current controlled inverter.

19. A controller for controlling a set of power generating units supplying power to an electrical grid, comprising:
a first routine, stored on a computer memory and executable on a processor, to determine during each of a plurality of cycle times and based on a predicted load demand over a near-term time horizon, one of the set of power generating units to operate in isochronous mode during a particular cycle time;
a first control routine, stored on a computer memory and executable on a processor, to operate the one of the set of power generating units in the particular cycle time in the isochronous mode to provide power to the electrical grid while performing frequency control on the electrical grid; and
a second control routine, stored on a computer memory and executable on a processor, to operate other ones of the set of power generating units in droop mode to provide additional power to the electrical grid.

20. The controller of claim 19, wherein the routine that determines the one of the set of power generating units to operate in the isochronous mode includes an optimization procedure that determines an optimal operating point for each of the set of power generating units based on overall power generating efficiency, and wherein the routine selects the one of the set of power generating units to operate in the isochronous mode as the largest capacity power generating unit that, when run at its associated optimal operating point, has a needed power output movement reserve to be able to control frequency on the power grid based on an expected change in the load demand over the near-term time horizon.
